(19) United States
(12) Patent Application Publication
(10) Pub. No.: US 2007/0057613 A1
(43) Pub. Date: Mar. 15, 2007

(54) Erosion resistant materials for spark plug components

(75) Inventors: Michael Patrick Brady, Oak Ridge, TN (US); Hua-Tay Lin, Oak Ridge, TN (US)

Correspondence Address: MICHAEL E. McKEE;Attorney at Law, 804 Swaps Lane, Knoxville, TN, 37923, US

(73) Assignee: UT-BATTELLE, LLC

(21) Appl. No.: 11/224,179

(22) Filed: Sep. 12, 2005

(51) Int. Cl. H01T 13/20

(52) U.S. Cl. 313/141; 313/143

(57) ABSTRACT

A spark plug for an internal combustion engine includes an electrode which is constructed of a Ni-, Co-, Cu- or Fe-base alloy material having MC-type carbide precipitates wherein M in the designation MC is one or a combination of a group of elements consisting of Hf, Mo, Nb, V, Ta, Ti, W and Zr. In addition, the spark plug also includes an insert tip which is constructed of an Re-modified Cr-base alloy.

This invention was made with Government support under Contract No. DE-AC05-00OR22725 awarded by the U.S. Department of Energy to UT-Battelle, LLC, and the Government has certain rights to the invention.

### BACKGROUND OF THE INVENTION

This invention relates generally to compositions of materials which resist oxidative wear and relates, more particularly, to electrode materials utilized in spark plugs for internal combustion (e.g. natural gas) engines.

One area of technology which has been identified by natural gas (NG) reciprocating engine manufacturers as requiring further advancement in order for natural gas engines to achieve desirable cost, performance, and emission characteristic goals relates to the ignition systems of such engines. In this connection, the erosion and subsequent failure of spark plugs have been recognized as major issues to be addressed as spark plug designers seek to achieve the long-term durability of natural gas ignition systems. The lifetimes of currently-available spark plugs are on the order of only 1000 to 4000 hours, and the degradation of any spark plug results in the loss of engine performance. Furthermore, spark plug replacement may require costly engine downtime. Still further, the need to frequently replace spark plugs in natural gas reciprocating engines which are used to provide continuous power for buildings is particularly undesirable.

Desired spark plug lifetimes for NG engine end users are on the order of at least 8000 hour (which corresponds to about one year of useful life). It has been recognized that as cylinder pressures, compression ratios, and ignition voltages of NG engines are increased, and steps are taken to reduce emissions through leaner burning, spark plug reliability and lifetime performance will become even more critical and could limit further advances in engine development.

Heretofore, the electrodes of spark plugs for natural gas engines typically consist of a Ni-based alloy, with Pt-base and/or Ir-base alloy insert tips. A study of worn plugs of the prior art (i.e. those whose electrodes are comprised of about 95% Ni) has lead to the identification of significant oxidation-spawned cracking of the electrodes, as well as material incompatibility-issues with the electrode insert tips, and in particular, the insert tips having a Pt-base material.

It would therefore be desirable to provide a spark plug for a natural gas (NG) reciprocating engine which improves upon the reliability and lifetime performance of spark plugs of the prior art and which provides a significant advancement toward the achieving of desirable cost, performance, and emission characteristics goals for the ignition systems of NG engines.

Accordingly, it is an object of the present invention to provide a new and improved spark plug.

Another object of the present invention is to provide such a spark plug which is more reliable and provides a longer useful life than do spark plugs of the prior art.

Still another object of the present invention is to provide such a spark plug having an electrode which provides an improved resistance to erosion during use and is particularly well-suited for use in a natural gas (NG) reciprocating engine.

Yet another object of the present invention is to provide such a spark plug having an insert tip which is less expensive than the Pt-base and/or Ir-base alloy insert tips of the prior art and results in better sparking wear.

A further object of the present invention is to provide such a spark plug which is uncomplicated in structure, yet effective in operation.

### SUMMARY OF THE INVENTION

This invention resides in an improvement to a spark plug for an internal combustion engine. The plug includes a body through which a center electrode extends and about which a side electrode is positioned, and the center and side electrodes define a gap therebetween across which a spark is generated during use of the plug.

In one embodiment of the invention, the improvement is characterized in that at least one of the center and side electrodes is constructed of a Ni-, Co-, Cu- or Fe-base alloy or an alloy having a base including a combination of Ni, Co, Cu and Fe and wherein the electrode includes MC-type carbide precipitates disposed throughout wherein M in the designation MC is one or a combination of a group of elements consisting of Hf, Mo, Nb, V, Ta, Ti, W and Zr.

In another embodiment of the invention, there is associated with at least one of the center and side electrodes an one insert tip disposed adjacent the gap, and the improvement is characterized in that the insert tip is constructed of a Cr or Cr—Re alloy material or includes a quantity of MC-type carbide precipitates disposed throughout.

### BRIEF DESCRIPTION OF THE DRAWINGS

FIG. 1 is a longitudinal cross-sectional view of a spark plug within which features of the present invention are embodied.

FIG. 2 is a view of a fragment of the FIG. 1 spark plug.

FIG. 3 is a view of a portion of the FIG. 1 spark plug as viewed within the circle 3 of FIG. 2, but drawn to a slightly larger scale.

FIG. 4 is a micrograph of a solution-treated sample of material following a sparking screening test.

FIG. 5 is a view of the boxed area of the FIG. 4 micrograph, shown to a significantly larger scale.

FIG. 6 is a micrograph of a precipitate-including sample of material following a sparking screening test.

FIG. 7 is a micrograph of a Cr-6MgO sample of material following a sparking screening test.

FIG. 8 is a view of the boxed area of the FIG. 7 micrograph, shown to a significantly larger scale.

FIG. 9 is a micrograph of a Re-modified Cr-6MgO sample of material following a sparking screening test.

### DETAILED DESCRIPTION OF AN ILLUSTRATIVE EMBODIMENT

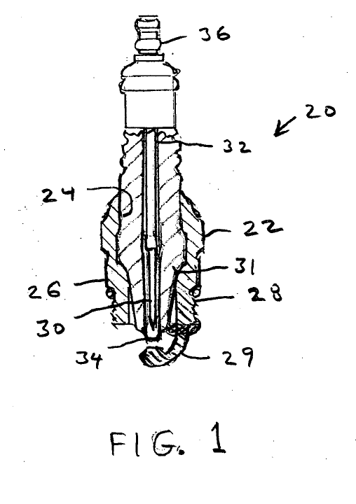

Turning now to the drawings in greater detail and considering first FIG. 1, there is illustrated an embodiment, generally indicated 20, of a spark plug for an internal combustion engine within which features of the present invention are embodied. More specifically, the spark plug 20 includes an outer shell 22 having an internal passageway 24 and an outer surface 26 having an externally-threaded portion 28 which permits the plug 20 to be threadably-accepted by the internally-threaded spark plug opening (not shown) provided in an internal combustion engine and a side electrode 29 integrally joined to the threaded section of the shell 22. The spark plug 20 further includes a center electrode 30 which extends centrally through the plug 20 and a molded insulator 31 which is positioned about the center electrode 30 to insulate the electrode 30 from the shell 22.

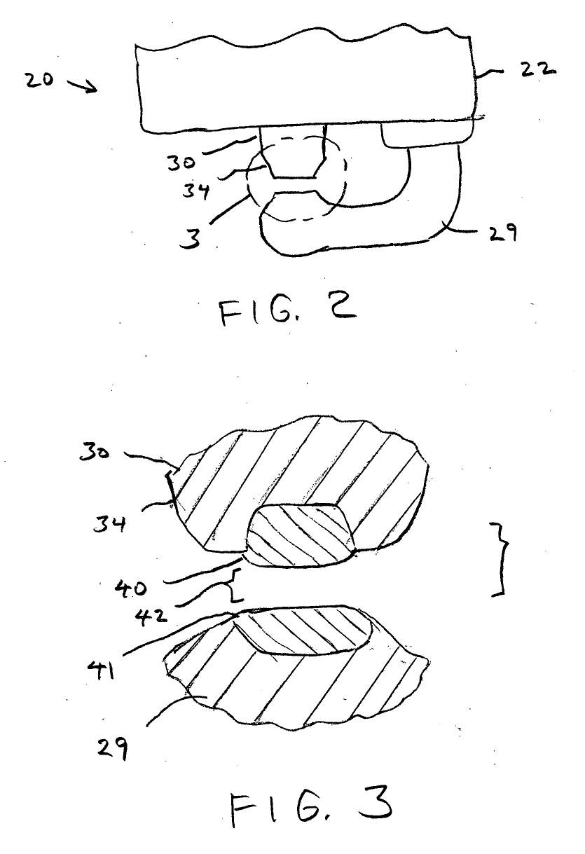

With reference to FIGS. 1-3, the center electrode 30 has a proximal end 32 which is disposed adjacent a conductor 36 to which a spark plug wire (not shown) is connected and a distal end 34 which is situated adjacent the end of the plug 20 corresponding with the side electrode 29. In addition, one insert tip 40 is embedded within the distal end 32 of the electrode 30 so as to be in an electrically-conductive relationship therewith, and another insert tip 41 is embedded within the portion of the side electrode 29 which faces the insert tip 40. The insert tips 40 and 41 are spaced from one another by a gap 42, and it is across this gap 42 that a spark is generated by the plug 20 during use of the plug 20.

As will be apparent herein, it is the composition of each of the side and center electrodes 29 and 30, respectively, and the insert tips 40 and 41, respectively, which provide the plug 20 with an improved reliability and longer useful life. In this connection, each of the side and center electrodes 29 and 30 includes a base material of either a Ni- (nickel), Co- (cobalt), Cu- (copper) or Fe-(iron) based alloy, or a heat-resistant alloy including a base comprising a combination of Ni, Co, Cu and Fe, which has carbide dispersions throughout the electrode 30. To render such alloys heat-resistant, they normally also include protective scale-forming elements and additives, such as Al, Cr, Si or Ni.

The carbide dispersions throughout the electrode 30 are the carbides based on transition and refractory type elements, such as Hf, Mo, Nb, V, Ta, Ti, W, Zr and combinations thereof, and can be designated generally as MC-type carbides wherein M in the designation MC is one or a combination of the aforementioned elements. The MC-type carbides are preferable forms for the carbide dispersions due to their greater thermodynamic stability at elevated temperatures. Preferably, the electrode 29 or 30 has an optimum distribution of carbide precipitates for improved creep strength.

Along the lines of the foregoing, there is described in co-pending application Ser. No. 10/397,572, having the same assignee as the present invention, a wrought stainless steel alloy composition (i.e. a modified 347 steel material) which has an optimum dispersion of carbide (e.g. NbC) precipitates throughout the alloy and an exemplary process for developing this material. The stainless steel alloy (with the carbide precipitates disbursed throughout) described in this referenced co-pending application is an example of a Fe-based composition which is well-suited for use as the electrode 29 or 30 of the depicted plug 20. Furthermore, the suggested dispersion of intragranular NbC precipitates throughout the stainless steel alloy having a concentration in the range of 10¹⁰ to 10¹⁷ precipitates per cubic cm is adopted herein as a concentration range of carbide precipitates throughout the electrode 29 or 30.

For a more detailed description of the stainless steel alloy and the dispersion of carbide precipitates therethrough and the process with which such an alloy is developed, reference can be had to co-pending application Ser. No. 10/195,703, the disclosure of which is incorporated herein by reference.

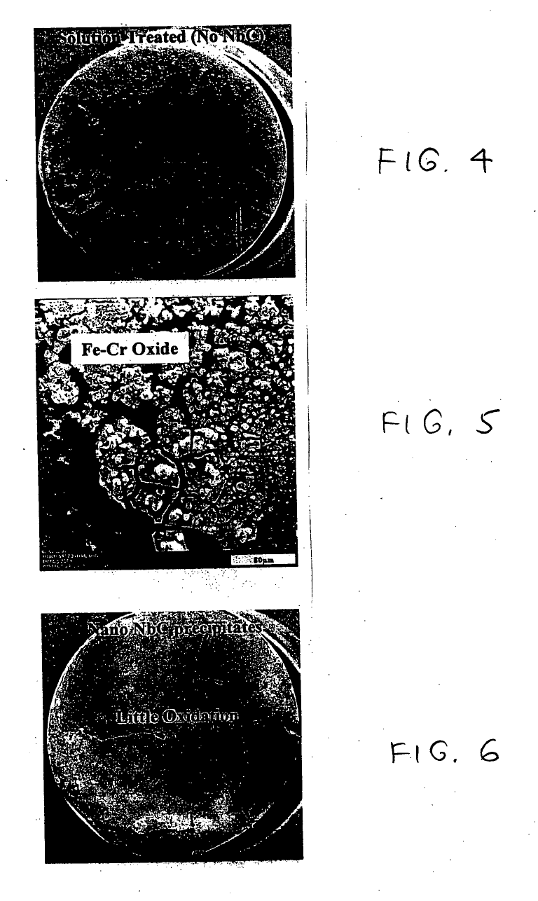

Applicants have substantiated by experiment the improvement in spark plug electrode wear due to the carbide dispersion therethrough. More specifically, a sample of the stainless steel material described in the referenced co-pending application (i.e. a modified 347 stainless steel material having an optimum distribution of MC-type carbide precipitates—primarily NbC—for improved creep strength) was compared to a sample of the identical stainless steel material processed in a similar manner but containing no carbide precipitates. To this end, applicants prepared a NbC-precipitated material (1200° C./1 h, 800° C./1 week heat treatment) and a solution-treated material (1200C., 1 h heat treat; no NbC precipitates) for their purposes of comparison. Sparking behavior in the samples (employed as the positive, or “+” electrode side) constructed out of ⅛″ diameter rods screened by 2×10⁶ shots at room temperature in air, using a wide 0.1″ gap distance to simulate the effects of pressure. FIGS. 4-6 show micrographs of solution-treated and NbC-precipitated 347 after the sparking screening test. In particular, FIG. 4 shows a micrograph of the solution-treated modified 347 stainless steel, FIG. 5 shows a micrograph of the boxed region of the FIG. 4 micrograph to a slightly larger scale, and FIG. 6 shows a micrograph of the same alloy which has been treated to precipitate nanoscale NbC phase particles.

It can be seen in the micrographs of FIGS. 4 and 5 that the solution-treated 347 stainless steel showed extensive oxidation), while the NbC precipitated material of FIG. 6 showed little attack. Such a difference exhibits a profound change in the effects of sparking behavior in the samples when carbide dispersions are present. Again, it should be noted that the samples being tested were of the same composition, but heat-treated differently prior to testing so that one sample possessed NbC dispersions while the other sample did not. Such a change was responsible for much less heating of the NbC-dispersed sample during sparking than was present in the sample possessing no carbide dispersions, and this lead to a reduced amount of oxidation in the NbC-dispersed sample than was the case with the sample possessing no carbide dispersions. It is believed that the mechanism which are responsible for this difference involves the lower work function of carbides which renders it easier to emit an electron. In addition, the aspects of reduced sputtering, the high melting point of carbides, and the hardening of the alloy might play a role in this mechanism, as well.

With reference again to FIGS. 1-3, it is also a feature of each insert tip 40 or 41 of the spark plug 20 that the insert tip 40 or 41 includes either chromium (Cr) or a chromium-rhenium (Cr—Re) alloy. More specifically, the amount of Cr within each insert tip is at least as great as 50 percent, by weight, and within Cr alloys which comprise the insert tip 40 or 41, the amount of Cr is greater than 90 percent, by weight. An example of an insert tip including Cr is a Cr insert tip having MgO dispersed throughout the Cr of the insert tip (i.e. 93.5 Cr-6 MgO-0.5 Ti). Examples of insert tips including Cr alloy are Cr-(2-6)MgO (0-1)Ti wt. % and Cr-5Fe-1Y₂O₃ wt. %. Whereas Cr is relatively brittle, the inclusion of MgO renders the insert tip relatively ductile.

The addition of Re to the Cr-based composition of the inert tip increases the melting point of the insert, which, in turn, results in an improved spark resistance. As far as the percentage of Re to Cr in the Cr—Re alloy is concerned, a percentage range of between zero to thirty-five atomic percent Re within the Cr—Re alloy is acceptable. The upper limit (i.e. the 35% atomic percent Re) corresponds with the solubility limit of Re in Cr. Considering, on the other hand, the weight percent of Re within the Cr—Re alloy, the weight percentage of Re within the Cr—Re alloy can range from zero to about sixty-five percent Re because Re is so heavy. Preferably, however, the weight percentage of Re within the Cr—Re alloy is within the range of between fifty and sixty-five percent by weight due to the increased melting temperature of the Cr—Re alloy by the Re addition. Up until about fifty percent by weight of Re is included within the Cr—Re alloy, the melting temperature of the Cr—Re alloy is only slightly increased.

Because of the inclusion of Cr or the Cr—Re alloy within the insert tip, the insert tip is less expensive than the Pt-base and/or Ir-base alloy insert tips of the prior art. Furthermore, because the melting point of Cr is higher than that of Pt, the insert tip is provided with a higher melting temperature and consequently, results in better sparking wear.

Applicants have conducted field tests on prior art spark plugs (i.e. those which include a Ni-base electrode and Pt-base and/or Ir-base alloy insert tips) in natural gas engines and have found that the wear on prior art spark plugs in such an environment is dominated by intergranular attack of the Pt/Ir alloy and oxidation-induced cracking at the weld interface between the Ni-base electrode and the Pt/Ir insert—and not dominated by the classic sparking mechanism, which is what would ordinally be expected. Unlike the composition of the insert tips of the prior art plugs, Cr alloys are highly resistant to the high temperature corrosion attack that was observed in the field-tested plugs and are not as susceptible to attacks at the grain boundaries as is the Pt/Ir insert tips. Moreover, the inclusion of Cr in the insert tip forms a protective Cr₂O₃ oxide scale at the Ni alloy/Cr interface. The high Cr concentration within the Cr alloy prevents extensive oxidation in the weld interdiffusion zone. This is in sharp contrast to Pt—Ni weld compositions at the Ni alloy/Pt interface in spark plugs of the prior art which oxidize relatively rapidly.

Other modifications of the Cr or Cr—Re alloy insert tip can include the addition of MgO from zero to six percent, by weight. The addition of MgO to the insert tip can improve oxidation resistance and ductility. The insert tip can also be improved with the addition of small amounts of Ni, W, or Ti.

Applicants selected for study a sample of a Cr-base alloy of composition Cr-6MgO wt % and a sample of the same alloy which includes a small quantity of Re by exposing the two samples to sparking screening tests for comparison purposes. Each sample were treated as if it were the positive, or “+”, electrode side, possessed a diameter of ⅛ inches and tested for 2×10⁶ sparking shots in air at room temperature. The Cr-base alloy used in these samples is a class of material developed in the early 1960s and exhibits useful levels of room-temperature ductility (Cr has a high brittle to ductile transition temperature and most Cr-base alloys are brittle at room temperature).

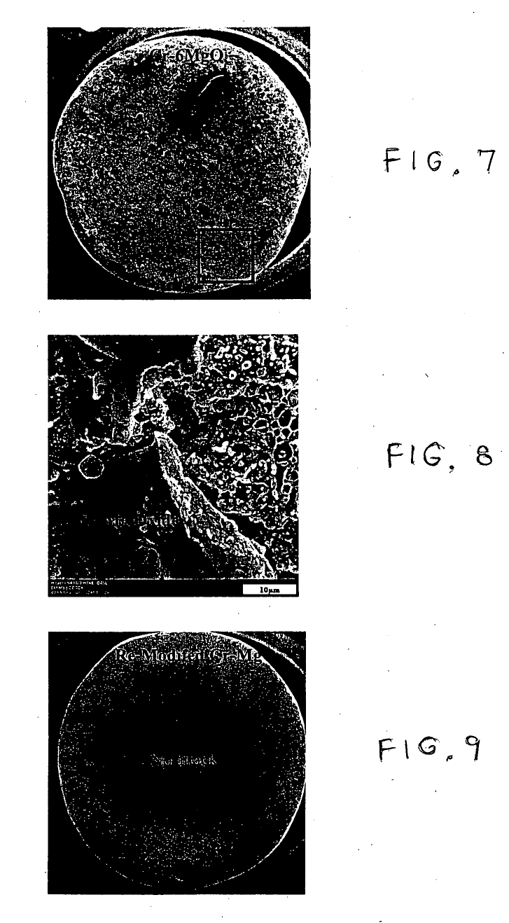

A can be seen from the test results depicted in the micrographs of FIGS. 7-9, only moderate attack and Mg—Cr oxide formation resulted from the sparking screening test conducted upon the samples. More specifically, the sample of non-Re-modified Cr-6MgO is depicted in the micrographs of FIGS. 7 and 8 (with the box region of FIG. 7 being shown in FIG. 8) while the sample of Re-modified Cr-6MgO is depicted in FIG. 9. The lack of oxide formation to the surface of the Re-modified Cr-6MgO sample (FIG. 9) as compared to that of the non-Re-modified Cr-6MgO sample leads one to conclude that Re additions significantly improve sparking resistance of the sample to the point that essentially no oxide attack was evident. The composition of the Re-modified Cr-6MgO sample was 60.2 Re-35.2 Cr-3.6 MgO-0.5 Ti-0.25 W-0.25 Ni wt % (1625° C., 2 hr, vacuum, 3 ksi, 3 inch nominal diameter). The additions of W and Ni were made to the sample based upon their value as sintering additives in Re alloys. Meanwhile, the Re addition was selected to raise the melting point of the material of the Re-modified Cr-6MgO sample (>2000° C. at this level of Re addition) and eliminate any detrimental effects of Cr(O) melting point depression. Further still, the addition of Re to Cr can improve the ductility of the resulting composition.

It will be understood that numerous modifications and substitutions can be had to the aforedescribed embodiment without departing from the spirit of the invention. For example, although the aforedescribed embodiment has been shown and described as including an insert tip 29 or 30 comprised of a Cr-base or a Cr—Re alloy, the aforedescribed concept of incorporating carbide dispersions throughout the electrode can be incorporated within the insert tip as well. In other words, an insert tip comprised of Cr-based or Cr—Re alloy or insert compositions of the prior art (which can include Pt, Ir, an element in a related platinum group, or a precious metal alloy) can be formed to possess carbide dispersions throughout so that the advantageous qualities possessed by an electrode containing carbide dispersions can be achieved with an insert tip, as well. Accordingly, the aforedescribed embodiment is intended for the purpose of illustration and not as limitation.

1. In a spark plug for an internal combustion engine having a body through which a center electrode extends and about which a side electrode is positioned, and wherein the center and side electrodes define a gap therebetween across which a spark is generated during use of the plug, the improvement characterized in that:
at least one of the center and side electrodes is constructed of a Ni-, Co-, Cu- or Fe-base alloy or an alloy having a base including a combination of Ni, Co, Cu and Fe and wherein the electrode includes MC-type carbide precipitates disposed throughout wherein M in the designation MC is one or a combination of a group of elements consisting of Hf, Mo, Nb, V, Ta, Ti, W and Zr.

2. The improvement as defined in claim 1 wherein the concentration of carbide precipitates throughout the at least one electrode is within the range of 10¹⁰ to 10¹⁷ precipitates per cubic cm.

3. The improvement as defined in claim 1 wherein the at least one electrode includes a Fe-base alloy and the carbides dispersed throughout the electrode are NbC precipitates.

4. The improvement as defined in claim 1 wherein there is associated with at least one of the center and side electrodes an insert tip disposed adjacent the gap, and the insert tip is constructed of a Cr-base or a Cr—Re alloy material.

5. The improvement as defined in claim 4 wherein the insert tip includes an amount of Re, and the amount of Re within the insert tip does not exceed about 65 percent by weight.

6. The improvement as defined in claim 1 wherein there is associated with at least one of the center and side electrodes an one insert tip disposed adjacent the gap, and the insert tip includes a quantity of MC-type carbide precipitates disposed throughout.

7. The improvement as defined in claim 1 wherein each of the center and side electrodes is constructed of a Ni-, Co-, Cu- or Fe-base alloy or an alloy having a base including a combination of Ni, Co, Cu and Fe and wherein each of the center and side electrodes includes MC-type carbide precipitates disposed throughout wherein M in the designation MC is one or a combination of a group of elements consisting of Hf, Mo, Nb, V, Ta, Ti, W and Zr.

8. The improvement as defined in claim 7 wherein there is associated with each of the center and side electrodes an insert tip which is disposed adjacent the gap, and the insert tip associated with each of the center and side electrodes is constructed of a Cr-base or Cr—Re alloy material.

9. The improvement as defined in claim 7 wherein the insert tip associated with each of the center and side electrodes further includes an amount of Re, and the amount of Re within an insert tip does not exceed about 65 percent by weight.

10. In a spark plug for an internal combustion engine having a body through which a center electrode extends and about which a side electrode is positioned, and wherein the center and side electrodes define a gap therebetween across which a spark is generated during use of the plug, the improvement characterized in that:
at least one of the center and side electrodes includes an insert tip disposed adjacent the gap, and the insert tip is constructed of a Cr-base or Cr—Re alloy material.

11. The improvement of claim 10 wherein the insert tip includes an amount of Re of no more than about 65 percent by weight.

12. The improvement of claim 10 wherein the insert tip of a Cr-base or a Cr—Re alloy material includes carbide dispersions throughout the body of the insert tip.

13. The improvement of claim 10 wherein the insert tip further includes a small quantity of material from a group of materials consisting of MgO, Ni, W, or Ti.

14. The improvement of claim 10 wherein each of the center and side electrodes includes an insert tip of a Cr-base or a Cr—Re-alloy material.

15. The improvement of claim 14 wherein the insert tip associated with each of the center and side electrodes includes an amount of Re, and the amount of Re within an insert tip does not exceed about 65 percent by weight.

16. The improvement of claim 10 wherein at least one of the center and side electrodes is constructed of a Ni-, Co-, Cu- or Fe-base alloy or an alloy having a base including a combination of Ni, Co, Cu and Fe and wherein the electrode includes MC-type carbide precipitates disposed throughout wherein M in the designation MC is one or a combination of a group of elements consisting of Hf, Mo, Nb, V, Ta, Ti, W and Zr.

17. The improvement as defined in claim 16 wherein the concentration of carbide precipitates throughout the at least one electrode is within the range of 10¹⁰ to 10¹⁷ precipitates per cubic cm.

18. The improvement as defined in claim 16 wherein the at least one electrode includes a Fe-base alloy and the carbides dispersed throughout the electrode are NbC precipitates.

19. In a spark plug for an internal combustion engine having a body through which a center electrode extends and about which a side electrode is positioned, and wherein the center and side electrodes define a gap therebetween across which a spark is generated during use of the plug, the improvement characterized in that:
at least one of the center and side electrodes includes an insert tip disposed adjacent the gap, and the insert tip includes a quantity of MC-type carbide precipitates disposed throughout.
